(19) United States
(12) Patent Application Publication
(10) Pub. No.: US 2014/0278450 A1
(43) Pub. Date: Sep. 18, 2014

(54) Searching for Service Providers based on Consumer Symptoms

(71) Applicant: Roy Schoenberg, Boston, MA (US)

(72) Inventor: Roy Schoenberg, Boston, MA (US)

(21) Appl. No.: 13/796,600

(22) Filed: Mar. 12, 2013

(51) Int. Cl. G06F 19/00

(52) U.S. Cl. CPC G06F 19/3425
USPC 705/2

(57) ABSTRACT

A computer-implemented method includes receiving a request to consult with a medical service provider; accessing a data repository that stores information pertaining to medical service providers, including present availability of the medical service providers for participating in a consultation and qualifications of the medical service providers; determining which of the medical service providers are presently available; identifying from the qualifications of the presently available medical service providers and the one or more terms included in the request, one or more medical service providers appropriate to consult with the consumer; transmitting information indicative of the identified one or more medical service providers appropriate to consult with the consumer regarding the consumer's one or more symptoms; receiving a selection of one of the identified one or more medical service providers; and establishing a communication channel between the device used by the consumer and a device used by the selected medical service provider.

### BACKGROUND

The present invention is directed to connecting consumers with service providers.

Systems have been developed to connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In one aspect of the present disclosure, a computer-implemented method includes receiving by a computer, a request from a consumer of medical services to consult with a medical service provider, with the request comprising one or more terms indicative of one or more symptoms of the consumer; processing by the computer the terms to establish one or more symptoms of the consumer of medical services; accessing a data repository that stores information pertaining to medical service providers, including present availability of the medical service providers for participating in a consultation and qualifications of the medical service providers; determining, in the computer, which of the medical service providers are presently available; identifying, in the computer from the qualifications of the presently available medical service providers and the one or more terms included in the request, one or more medical service providers appropriate to consult with the consumer regarding the consumer's determined one or more symptoms; transmitting, to a device used by the consumer, information indicative of the identified one or more medical service providers appropriate to consult with the consumer regarding the consumer's one or more symptoms; receiving a selection from the consumer of one of the identified one or more medical service providers appropriate to consult with the consumer regarding the consumer's one or more symptoms; and establishing a communication channel between the device used by the consumer and a device used by the selected medical service provider.

Implementations of the disclosure may include one or more of the following features. In some implementations, the computer is a brokerage system, and wherein accessing the data repository that stores the information pertaining to the medical service providers comprises: accessing a data repository that is external to the brokerage system and is integrated with a practice management system for medical service providers, with the external data repository storing information pertaining to the medical service providers associated with the practice management system, including present availability of the medical service providers associated with the practice management system for participating in a consultation and qualifications of the medical service providers associated with the practice management system; and wherein determining, in the computer, which of the medical service providers are presently available comprises: determining, in the computer based on the information accessed from the external data repository, which of the medical service providers associated with the practice management system are presently available.

In other implementations, identifying, from qualifications of the presently available medical service providers in the computer, one or more medical service providers appropriate to consult with the consumer regarding the consumer's one or more symptoms comprises: identifying, in the accessed information, symptom based attributes of the presently available medical service providers, with a symptom based attribute specifying symptoms that are appropriate for a particular medical service provider to address with the consumer.

In still other implementations, the method includes comparing the symptoms based attributes to the one or more terms included in the request; determining, based on comparing, a match between one of the symptom based attributes and at least one of the one or more terms; and identifying a medical service provider associated with the symptom based attribute matching the at least one of the one or more terms included in the request. In yet other implementations, the method includes generating, by the computer, a graphical user interface that when rendered on a display device, renders: visual representations of the identified one or more medical service providers appropriate to consult with the consumer regarding the consumer's one or more symptoms; wherein transmitting, to the device used by the consumer, the information comprises: transmitting the graphical user interface to the device used by the consumer.

In other implementations, the method includes determining, based on contents of the request, that the consumer is requesting a consultation with a medical service provider associated with a provider practice and appropriate for a consultation regarding the one or more symptoms of the consumer; wherein accessing the data repository comprises: accessing the data repository for information pertaining to medical service providers associated with the particular provider practice, with the accessed information including present availability of the medical service providers associated with the particular provider practice for participating in a consultation and qualifications of the medical service providers associated with the particular provider practice.

In another aspect of the disclosure, one or more machine-readable storage media are configured to store instructions for causing one or more processing devices to perform operations comprising: receiving a request from a consumer of medical services to consult with a medical service provider, with the request comprising one or more terms indicative of one or more symptoms of the consumer; processing the terms to establish one or more symptoms of the consumer of medical services; accessing a data repository that stores information pertaining to medical service providers, including present availability of the medical service providers for participating in a consultation and qualifications of the medical service providers; determining which of the medical service providers are presently available; identifying, from the qualifications of the presently available medical service providers and the one or more terms included in the request, one or more medical service providers appropriate to consult with the consumer regarding the consumer's determined one or more symptoms; transmitting, to a device used by the consumer, information indicative of the identified one or more medical service providers appropriate to consult with the consumer regarding the consumer's one or more symptoms; receiving a selection from the consumer of one of the identified one or more medical service providers appropriate to consult with the consumer regarding the consumer's one or more symptoms; and establishing a communication channel between the device used by the consumer and a device used by the selected medical service provider. Implementations of this aspect of the present disclosure can include one or more of the foregoing features.

In still another aspect of the disclosure, a system includes one or more processing devices; and one or more machine-readable media configured to store instructions that are executable to cause the one or more processing devices to perform operations comprising: receiving a request from a consumer of medical services to consult with a medical service provider, with the request comprising one or more terms indicative of one or more symptoms of the consumer; processing the terms to establish one or more symptoms of the consumer of medical services; accessing a data repository that stores information pertaining to medical service providers, including present availability of the medical service providers for participating in a consultation and qualifications of the medical service providers; determining which of the medical service providers are presently available; identifying, from the qualifications of the presently available medical service providers and the one or more terms included in the request, one or more medical service providers appropriate to consult with the consumer regarding the consumer's determined one or more symptoms; transmitting, to a device used by the consumer, information indicative of the identified one or more medical service providers appropriate to consult with the consumer regarding the consumer's one or more symptoms; receiving a selection from the consumer of one of the identified one or more medical service providers appropriate to consult with the consumer regarding the consumer's one or more symptoms; and establishing a communication channel between the device used by the consumer and a device used by the selected medical service provider. Implementations of this aspect of the present disclosure can include one or more of the foregoing features.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more embodiments are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of an engagement brokerage service.

FIG. 2 is a screen shot of a graphical user interface depicting service providers qualified to address various consumer symptoms.

FIGS. 3 and 4 are flowcharts of processes useful in understanding the engagement brokerage service.

FIG. 5 is a block diagram of a computer (computer system) showing exemplary components that can be used for the brokerage system and/or client systems.

### DETAILED DESCRIPTION

Overview

The system described below provides an integrated information and communication platform that enables consumers of services to identify and select service providers for brokered engagements. Through the platform, consumers search for service providers who are qualified to address one or more consumer symptoms and select one of the qualified service providers for a consultation. This integrated platform is referred to herein as an engagement brokerage service (brokerage).

FIG. 1 shows an example system 100 implementing the brokerage service. The system 100 includes a computerized system or server 110 for making connections between consumers 120, at client systems 122, including mobile devices and PDAs, and service providers 130, at client systems 132, over a network 140, e.g., the Internet or other types of networks. The computerized system 110 operates as a service running on a web server 102. Client systems 122, 132 include processing devices, mobile devices, PDAs, and other computing devices.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider may be contacted. In some examples of an active system, the provider's mobile device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number of the provider's mobile device with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art.

Using the system 100, a consumer 120 communicates with a provider 130. The consumers 120 and providers 130 connect to the computerized system 110 through a graphical user interface displayed on a mobile device and served by the web server 102 using client devices 122 and 132, respectively. Client devices 122 and 132 include any combination of mobile devices, PDAs, cellular phones and so forth. The client devices 122 and 132 enable the consumers 120 to input and receive information as well as to communicate via video, audio, and/or text with the providers 130.

The computerized system 110 provides information and services to the consumers 120 in addition to connecting them with providers 130. The computerized system 110 includes an access control facility 114, which manages and controls whether a given consumer 120 has privileges to access the system 110 and what level or scope of access to the features, functions, and services the system 110 provides.

The consumer 120 uses the system 100 to find out more information about a topic of interest or, for example, a potential medical condition. The computerized system 110 identifies service providers 130 that are available at any given moment to communicate with a consumer about a particular product, service, or related topic or subject, for example, a medical condition. The computerized system 110 facilitates communication between the consumer 120 and provider 130, enabling them to communicate, for example, via a data-network-facilitated video or voice communication channel (such as Voice over IP), mobile telephone network channels, and instant messaging or chat. In some examples, the availability of one or more providers 130 is tracked, and at the instant a consumer 120 desires to connect and communicate with a provider, the system 110 determines whether a provider is available through the provider's mobile device.

The system selects a mode of communication to use based in part on the relative utility of the various modes. The preferred mode for an engagement is for both the consumer 120 and the provider 130 to use graphical user interfaces, which are displayed on mobile devices. For example, consumers and providers launch chat sessions, voice calls, or video chats from within a graphical user interface.

If the provider 130 is not available, the system 110 identifies other available providers 130 that would meet the consumer's needs. The system 110 enables the consumer 120 to send a message to the consumer's chosen provider. The consumer also has the system 110 contact the consumer in the future when the chosen provider is available.

The system enables the consumer to search for providers that are available at the time the consumer is searching and enables the consumer to engage a provider on a transactional basis or for a one-time consultation. A consumer is able to engage a world-renowned specialist for a consultation or second opinion, even though the specialist is located too far away from the consumer to become a regular client, patient, or consumer.

The consumer uses that specialist's advice when considering services by a local service provider. For example, a patient in a suburban town with a rare condition consults with a specialist in a distant city, and then, based on that consultation, selects a local physician for treatment.

Database 118 stores various information, including, e.g., provider information 146, 148, 150 and symptom based attributes 140, 142, 144. Provider information 146, 148, 150 is associated with symptom based attributes 140, 142, 144, respectively. Provider information includes information that identifies a particular service provider, including, e.g., a name of the service provider or identification information that is uniquely associated with the service provider. Symptom based attributes include information specifying one or more symptoms that a service provider is qualified to address with a consumer.

Brokerage system 110 generates associations between a provider and symptom based attributes based on information (e.g., qualifications) a service provider enters into brokerage system 110, e.g., when registering with brokerage system 110. The entered information may specify a practice area of the service provider. For example, when the service provider specifies that he/she is an internist, brokerage system 110 accesses in database 118 a pre-defined mapping (not shown) of various symptom based attributes that an internist is qualified to address with a consumer. Brokerage system 110 selects, from the pre-defined mapping, those symptom based attributes that are associated with an internist and generates an association between the selected based attributes and the provider information. In another example, a service provider enters into brokerage system 110 information specifying symptoms that the service provider is qualified to address. Brokerage system 110 generates associations among provider information for the service provider and symptom based attributes specified by the entered information.

System 100 also includes practice management system 121, which is a system that is external to brokerage system 110 and is associated with a physical location of a service provider (e.g., an office of a service provider). For example, practice management system 121 is associated with a provider practice (e.g., a physical office). Practice management system 121 maintains information indicative of service providers and which symptoms a service provider is qualified to address. Practice management system 121 maintains provider information 152, 154, 156 in association with symptom based attributes 158, 160, 162, respectively. Provider information 152, 154, 156 specifies service providers who are associated with (included in) the provider practice that uses practice management system 121. The service providers who are associated with (included in) the provider practice input into practice management system 121 information specifying symptoms that the service provider is qualified to address with a consumer. Based on the input information, practice management system 121 generates associations among provider information 152, 154, 156 and symptom based attributes 158, 160, 162, respectively.

Practice management system 121 generates associations between a provider and symptom based attributes based on information (e.g., qualifications) a service provider enters into practice management system 121. The entered information may specify a practice area of the service provider. For example, when the service provider specifies that he/she is an internist, practice management system 121 a pre-defined mapping (not shown) of various symptom based attributes that an internist is qualified to address with a consumer. Practice management system 121 selects, from the pre-defined mapping, those symptom based attributes that are associated with an internist and generates an association between the selected based attributes and the provider information.

Brokerage system 110 includes search engine 115 for searching database 118 and/or practice management system 121 for service providers who are qualified to address various consumer symptoms. Client device 122 sends request 133 to brokerage system 110. Request 133 includes information (e.g., terms) specifying one or more symptoms that are experienced by consumer 120. Request 133 also includes a request for a real-time consultation with a service provider who is qualified to address the one or more symptoms of consumer 120.

In response to receipt of request 133, search engine 115 searches database 118 for symptom based attributes (e.g., symptom based attributes 140, 142, 144) matching the symptom terms included in request 133. Upon determining a match, brokerage system 110 identifies the service provider information (e.g., one or more items of service provider information 146, 148, 150) associated with the matching symptom based attributes. Brokerage system 110 also determines the present availability of the identified service providers who are qualified to address the consumer symptoms.

In a variation, request 133 includes information specifying consumer symptoms and a request to consult with service providers who are qualified to address the consumer symptoms and who are associated with a particular provider practice. Using contents of request 133, brokerage system 110 identifies that the requested provider practice is associated with practice management system 121. Database 118 stores information specifying associations between provider practice names and network information (e.g., IP addresses) for practice management systems used by the provider practices. Request 133 includes information specifying a name of a provider practice. Using the specified name of the provider practice, brokerage system 110 identifies the network information that is associated with the specified name of the provider practice. Brokerage system 110 identifies network information for provider practice system 121.

Using the network information, search engine 115 accesses practice management system 121 and searches for service providers associated with symptom based attributes that match the consumer symptoms specified in request 133. Search engine 115 identifies service providers associated with the request provider practice and associated with symptom based attributes that match the consumer symptoms specified in request 133. Brokerage system 110 identifies the available of the identified service providers. Brokerage system 110 transmits, to client device 122, information indicative of one or more available service providers who are associated with the requested provider practice, who are available and who are qualified to address the consumer's symptoms.

In a variation of FIG. 1, database 118 stores provider information for particular provider practices, e.g., to indicate which service providers are associated with which provider practices. Database 118 stores the provider information for the particular provider practices in association with various symptom based attributes.

Providers participating in the brokerage network have several states of availability over time. States in which the provider are available include on-line, in which the provider is logged-in and accepts new engagements in any mode, on-line (busy), in which the provider is logged-in but is currently occupied in a video or telephonic engagement, and scheduled, in which the provider is offline but is scheduled to be online at a designated time-point and pre-schedule engagements for it. While not online, the provider takes messages as in offline state. Other states include off-line, in which the provider is not logged in but takes message-based engagements (i.e., asynchronous engagements), out-of-office, in which the provider is not accepting engagements or messages, and standby, in which the provider is offline and is paged to Online status by the brokerage network if traffic load demands it (in some examples, consumers see this state as offline).

The operating business model for the provider network employs a remuneration scheme for providers that helps assure that the consumers find providers in designated professional domains (e.g., pediatrics) in the online mode. For example, selected providers are remunerated for being in the standby mode to encourage their on-line availability in case of low discretionary availability by other providers in their professional domain. Standby providers are also called into the on-line state when the fraction of on-line (busy) providers in their professional domain exceeds a certain threshold. In some examples, the transition of providers from standby to online and back to standby (in case of over capacity or idle capacity) is an automated function of the system.

The tracking module 112 transfers 154 information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

As noted, the system 100 includes access control facilities 114 that control how consumers 120 access the system and to what extent or level the services provided by the system are made available to consumers. The system 100 also stores and provides access to consumer information (e.g., contact information, credit and financial information, credit card information, health information, and other information related to the consumer and the services purchased or otherwise used by the consumer) and provider information (e.g., physician biographies, product and service information, health related content and information and any information the provider or the health plan wants to make available to members) and the access control facility 114 prevents unauthorized access to this information. In some examples, the system 100 exports the consumer information for use in a provider's office or other facility.

The system 100 interacts with consumers and available data sources to position and direct their health matters to appropriate care providers. Consumers use various tools of physician and provider profiling to exercise choice in selecting the providers they wish to interact with. The brokerage facilitates the communication between the consumer and his selected providers, allowing the consumer to follow-up as needed to establish a comfort level in his care. The brokerage supports transfer of these communications and any other results of the eVisit to non-virtual care points if such escalation is needed.

The brokerage is considered a first tier of medical care that is made available to consumers at home or at other locations. This first tier precedes typical entry points into a medical care setting, e.g., a physician's office or an emergency room. The brokerage enables consumers to explore concerns on, new or existing medical issues without the need to incur the time, cost, and emotional burden typically associated with the office visits or trips to the emergency room. To deliver such a comfort level, the system provides immediate access to tools that help define health issues, as well as, access to the appropriate automated and human mediated interventions. Consumers discretionally engage (or escalate) the level of care they need to gain confidence in their management of such issues. The consumers' choices in this area span both the type of credentials of the provider they interact with (e.g., a nurse versus a board certified specialist), as well as the level of intensity (mode and frequency) of their communications (e.g., messages versus full video dialogue). The brokerage exports the information and workup gained during an encounter to a subsequent tier of services, such as a specific medical office or the ER (as well as care management services if offered by the consumer's health plan, hospitals and so forth). As such, the brokerage manages more costly medical service consumption (demand management) and serves as a pervasive tool for impacting basic medical care and follow-up and encourages appropriate health behaviors for the customer population at large.

There are various models for how consumers gain access to the system. Consumers purchase access to the system through a variety of models, including direct payment or as part of their insurance coverage. Health plans provide access to their members as part of their service or as an optional added benefit. In some examples, health plans receive information about their members' use of the brokerage to allow, for example, better allocation of resources and overall management of member's health care consumption. Employers purchase access to the brokerage for their employees through whichever health plans the employer offers. Self-insured employers purchase access for their employees directly with the brokerage. Providers are compensated in several ways and offer their services to the brokerage either independently or as part of a framework such as a provider network.

Similarly, there are numerous ways the brokerage is packaged. As a health plan benefit, the brokerage expands a health plans ability to manage health care service consumption by their members. A health plan provides access to the brokerage through an existing web portal, accessible over mobile devices, through which members access benefit information and interact with their health plan. As an employee benefit, the brokerage supplements the employee's health coverage and is presented, for example, through a human resources web site, accessible over mobile devices. In a direct-to-consumer situation, consumers access the brokerage directly through its own graphical user interface displayed on a mobile device. In some examples, the brokerage is implemented as an enterprise software system for a call center, such as one operated by a health care provider. Linked to other institutional users of the system (e.g., other participating providers), this allows the provider to provide services to its patients that it cannot offer itself, such as 24-hour specialty consultations. The brokerage is also used by a provider practice to allows its practitioners to provide care to the brokerage's members (and generate revenue) during off-hours or as a preliminary stage to office visits. This eliminates the need for an office visit with a primary care physician just to get a referral to a specialist.

The brokerage provides compensation for products and services provided. Access to the system 100 is provided on a subscription basis, with consumers paying a fee (either directly or indirectly through another party, such as a healthcare plan or health insurance provider) to be provided with a particular level of access to the system. In exchange for providing products or services, the service provider receives compensation from the consumer or from an organization that pays for the products or services on behalf of the consumer, such as a health plan or a health insurance company. In instances in which the consumer pays directly, the operator of the interface to the system that connected the consumer to the service provider is compensated. In one embodiment, the consumer pays the operator, which keeps a portion (e.g., a percentage, a flat fee, or a co-pay) and pays the remainder to the service provider. In another embodiment, the consumer or the service provider pays a flat fee or percentage of the fee for the engagement to the operator. Where the service provider's compensation is paid by a health plan or insurance company, the operator is paid a flat fee or a percentage of the fee for the engagement transaction by the health plan or insurance company. Alternatively, the consumer or the service provider or both pays a fee (a co-pay or service fee) to the operator for providing the connection.

Referring to FIG. 2, brokerage system 110 generates data for graphical user interface 170 (e.g., for display on client device 122). Graphical user interface 170 is associated with a particular provider practice represented in portion 174 of graphical user interface 170. Graphical user interface 170 is accessed from uniform resource location (URL) that is associated with the provider practice.

Graphical user interface 170 includes search box 172 for entry of one or more symptoms (e.g., “cough”) that are experienced by a consumer. Graphical user interface 170 includes control 183, selection of which causes client device 122 to send, to brokerage system 110, a request for available service providers who are available, who are qualified to address the symptoms entered into search box and who are associated with the provider practice represented in portion 174 of graphical user interface 170.

Upon receiving the request, brokerage system 110 identifies one or more service providers who are currently available for consumer consultations, who are qualified to address the consumer symptom(s) entered in search box 172 and who are associated with the provider practice represented in portion 174. Brokerage system 110 causes graphical user interface 170 to be updated with information 176, 178, 180, 182, 184, 186, 188, 190, 192 that represent one or more of the identified service providers.

Brokerage system 110 identifies that service providers represented by information 176, 178, 180, 182, 184, 188, 190 are available to engage in a consultation with consumer 120. Items of information 176, 178, 180, 182, 184, 188, 190 include visual representations of service providers and other information specifying a name of a service provider, a star rating of the service provider, and a practice area (or specialty) of the service provider.

Brokerage system 110 selects these service providers represented by information 176, 178, 180, 182, 184, 188, 190 based on service provider availability and based on a match among one or more of the symptom based attributes associated with these service providers and the symptom(s) input into search box 172.

Upon receiving the request for a consultation with a service provider who is qualified to address consumer symptoms, brokerage system 110 also identifies service providers who are not available but who are qualified to address consumer symptoms. Brokerage system 110 identifies these unavailable service providers based attributes associated with the unavailable service providers. For example, brokerage system 110 identifies these unavailable service providers based on a specialty and/or a provider type associated with these unavailable service providers.

For example, brokerage system 110 identifies available service providers that are associated with various specialties that qualify these service providers to address the consumer symptoms. Brokerage system 110 is unable to identify an available service provider associated with a particular specialty (e.g., cardiology) that is also qualified to address the consumer symptom. Brokerage system 110 identifies unavailable service providers who are associated with the particular specialty and selects one or more of the unavailable service providers for representation in graphical user interface 170. Brokerage system 110 identifies service providers represented by information 186, 192 as being unavailable but represented in graphical user interface 170. Graphical user interface 170 displays information 186, 192 representing service providers who are unavailable, who are qualified to address the consumer symptoms and with whom a consumer can schedule an appointment.

Graphical user interface 170 also displays controls 194, 196, 198, 200, 202, 204, 206 selection of which (by consumer 120) causes brokerage system 110 to establish a communication channel between device 122 used by consumer 120 and a device used by a service provider associated with the selected control.

One or more controls 194, 196, 198, 200, 202, 204, 206 are color coded to indicate communication modes in which service providers are available for consultations. One color indicates that a service provider is only available for telephonic engagements. Another color indicates that a service provider is available for text-based online communications, telephonic communications and video-based communications.

Graphical user interface 170 also displays information 208 to indicate that a service provider is available but not currently available. Information 208 specifies that a service provider is currently engaged with a consumer. Selection of control 202 places an entry for consumer 120 in a queue of consumers who are waiting for consultations with the service provider represented by information 184. When the entry for consumer 120 is first in the queue, brokerage system 110 takes the entry out of the queue and establishes a communication between device 122 used by consumer 120 and a device used by the service provider represented by information 184.

The service providers represented by information 174, 176, 178, 180, 183, 184, 186, 188, 190, 192 are associated providers, e.g., providers who are associated with a provider practice (e.g., the provider practice specified in portion 174 of graphical user interface 170). For example, information 174, 176, 178 represents service providers associated with provider information 152, 154, 156 (FIG. 1). In a variation of FIG. 2, graphical user interface 170 displays information representing service providers associated with provider practices and information representing service providers unassociated with provider practices (“unassociated service providers”). Graphical user interface 170 displays information representing associated service providers associated with provider information 152, 154, 156 and information representing unassociated service providers associated with provider information 146, 148, 150 (FIG. 1).

Referring now to FIG. 3, the computerized system 110 tracks 220 the availability of providers 130 who are qualified to address the consumer symptoms (and who are associated with requested provider practices). A provider 130 logs (222) into the system 100. The provider 130 identifies associated provider practices, if any. The provider 130 also specifies a provider type and/or various symptoms that the provider is qualified to address with a consumer. Based on the provider type and or the entered symptoms, brokerage system 110 identifies one or more symptom based attributes and generates associations between the symptom based attributes and provider information for the service provider.

The provider 130 indicates (224) (such as by setting a check box or selecting a menu entry or by responding to a voice prompt) to the tracking module 112 that he or she is available to interact with consumers 120. The provider 130 can also indicate (226) to the tracking module 112 (such as by setting a check box or selecting a menu entry or by responding to a voice prompt) the modes (e.g., telephone, chat, video conference) by which a consumer 120 can be connected to the provider 130. Alternatively, the tracking module 114 determines (228) the capabilities of the terminals 122 and 132 the consumer 120 and the provider 130 use to connect to the system (for example, by using a terminal-based program to analyze the hardware configuration of each terminal). Thus, if a provider 130 connects to the system 100 by a desktop computer and the provider has a video camera connected to that computer, the tracking module 112 determines that the provider 130 can be engaged by text (e.g., chat or instant messenger), voice (e.g., VoIP) or video conference. Similarly, if a provider 130 connects to the system using a handheld device such as a PDA, the tracking module 112 infers (230) that the provider 130 can be engaged by text or voice. The tracking module 112 can also infer a provider's availability and modes of engagement by the provider's previously provided profile information and the terminal device through which the provider connects to the system.

The tracking module 112 transfers (232) information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

Referring to FIG. 4, brokerage system 110 implements process 240 in searching for service providers who are qualified to address various consumer symptoms. In operation, brokerage system 110 receives (242), from client device 122, a request for a consultation with an available service provider who is qualified to address various symptoms with the consumer. The request includes one or more terms that are indicative of symptoms being experienced with the consumer. The request may also specify a particular provider practice from which to identify providers who are candidates for the consultation.

In response to the request, brokerage system 110 identifies (244) the requested provider practice. Using contents of the request, brokerage system 110 also determines (246) one or symptoms that are experienced by the consumer, e.g., based on the one or more terms included in the request. Brokerage system 110 uses various techniques in identifying symptoms. In an example, a user enters terms into a search box (e.g., search box 172 in FIG. 2). In this example, the entered terms are indicative of a symptom and match (e.g., correspond to) one or more of symptom based attributes. In another example, the terms entered into the search box differ from the symptom based attributes. In this example, brokerage system 110 (and/or practice management system 121) accesses a mapping of various terms to various symptoms. For example, the term “hurt” is not a symptom itself but is mapped in the mapping to the term “pain,” which is a symptom. Based on the contents of the mapping and based on the terms entered into the search box, brokerage system 110 identifies one or more symptoms, e.g., by determining a correspondence between a term (e.g., the term entered in the search box) in the mapping and a symptom in the mapping.

Brokerage system 110 accesses (248) provider information and associated symptom based attributes, e.g., from practice management system 121 and/or from databases 118. Using the accessed information, brokerage system 110 searches (250) for service providers associated with symptom based attributes that match at least a portion of the symptom terms included the request. Based on the searching, brokerage system 110 identifies (252) service providers who are associated with symptom based attributes that match at least one of the symptom terms. From the identified service providers, brokerage system 110 determines which of the identified service providers are available for the requested consultation with the consumer.

Brokerage system 110 generates (254) data for a graphical user interface that displays visual presentations of the available service providers associated with the requested provider practice who are qualified to address the consumer symptoms. Brokerage system 110 receives (256) information indicative of a selection of one of the service providers represented in the graphical user interface. In response to the selection, brokerage system 110 establishes (258) a communication channel between a device used by the consumer and a device used by the selected service provider.

FIG. 5 is a block diagram of components 260 of the engagement brokerage system. User devices 288 can be any sort of computing device capable of taking input from a user and communicating over a network (not shown) with server 110 and/or with other client devices. For example, user device 288 can be a mobile device, a desktop computer, a laptop, a cell phone, a personal digital assistant (“PDA”), a server, an embedded computing system, a mobile device and so forth. User devices 288 include monitor 270 which render visual representations of interface 266.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device user device 288 via interfaces 266, including, e.g., graphical user interfaces. Interfaces 266 can be any type of interface capable of receiving information over a network, such as an Ethernet interface, a wireless networking interface, a fiber-optic networking interface, a modem, and so forth. Server 110 also includes a processor 262 and memory 264. A bus system (not shown), including, for example, a data bus and a motherboard, can be used to establish and to control data communication between the components of server 110.

Processor 262 may include one or more microprocessors. Generally, processor 262 may include any appropriate processor and/or logic that is capable of receiving and storing data, and of communicating over a network (not shown). Memory 264 can include a hard drive and a random access memory storage device, such as a dynamic random access memory, machine-readable media, or other types of non-transitory machine-readable storage devices.

Components 260 also include storage device 272, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device for execution by a programmable processor; and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. For example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprises:
receiving by a computer, a request from a consumer of medical services to consult with a medical service provider, with the request comprising one or more terms indicative of one or more symptoms of the consumer;
processing by the computer the terms to establish one or more symptoms of the consumer of medical services;
accessing a data repository that stores information pertaining to medical service providers, including present availability of the medical service providers for participating in a consultation and qualifications of the medical service providers;
determining, in the computer, which of the medical service providers are presently available;
identifying, in the computer from the qualifications of the presently available medical service providers and the one or more terms included in the request, one or more medical service providers appropriate to consult with the consumer regarding the consumer's determined one or more symptoms;
transmitting, to a device used by the consumer, information indicative of the identified one or more medical service providers appropriate to consult with the consumer regarding the consumer's one or more symptoms;
receiving a selection from the consumer of one of the identified one or more medical service providers appropriate to consult with the consumer regarding the consumer's one or more symptoms; and
establishing a communication channel between the device used by the consumer and a device used by the selected medical service provider.

2. The computer-implemented method of claim 1, wherein the computer is a brokerage system, and wherein accessing the data repository that stores the information pertaining to the medical service providers comprises:
accessing a data repository that is external to the brokerage system and is integrated with a practice management system for medical service providers, with the external data repository storing information pertaining to the medical service providers associated with the practice management system, including present availability of the medical service providers associated with the practice management system for participating in a consultation and qualifications of the medical service providers associated with the practice management system; and
wherein determining, in the computer, which of the medical service providers are presently available comprises:
determining, in the computer based on the information accessed from the external data repository, which of the medical service providers associated with the practice management system are presently available.

3. The computer-implemented method of claim 1, wherein identifying, from qualifications of the presently available medical service providers in the computer, one or more medical service providers appropriate to consult with the consumer regarding the consumer's one or more symptoms comprises:
identifying, in the accessed information, symptom based attributes of the presently available medical service providers, with a symptom based attribute specifying symptoms that are appropriate for a particular medical service provider to address with the consumer.

4. The computer-implemented method of claim 3, further comprising:
comparing the symptoms based attributes to the one or more terms included in the request;
determining, based on comparing, a match between one of the symptom based attributes and at least one of the one or more terms; and
identifying a medical service provider associated with the symptom based attribute matching the at least one of the one or more terms included in the request.

5. The computer-implemented method of claim 1, further comprising:
generating, by the computer, a graphical user interface that when rendered on a display device, renders:
visual representations of the identified one or more medical service providers appropriate to consult with the consumer regarding the consumer's one or more symptoms;
wherein transmitting, to the device used by the consumer, the information comprises:
transmitting the graphical user interface to the device used by the consumer.

6. The computer-implemented method of claim 1 further comprising:
determining, based on contents of the request, that the consumer is requesting a consultation with a medical service provider associated with a provider practice and appropriate for a consultation regarding the one or more symptoms of the consumer;
wherein accessing the data repository comprises:
accessing the data repository for information pertaining to medical service providers associated with the particular provider practice, with the accessed information including present availability of the medical service providers associated with the particular provider practice for participating in a consultation and qualifications of the medical service providers associated with the particular provider practice.

7. One or more machine-readable storage media storing instructions that are executable by one or more processing devices to perform operations comprising:
receiving a request from a consumer of medical services to consult with a medical service provider, with the request comprising one or more terms indicative of one or more symptoms of the consumer;
processing the terms to establish one or more symptoms of the consumer of medical services;
accessing a data repository that stores information pertaining to medical service providers, including present availability of the medical service providers for participating in a consultation and qualifications of the medical service providers;
determining which of the medical service providers are presently available;
identifying, from the qualifications of the presently available medical service providers and the one or more terms included in the request, one or more medical service providers appropriate to consult with the consumer regarding the consumer's determined one or more symptoms;
transmitting, to a device used by the consumer, information indicative of the identified one or more medical service providers appropriate to consult with the consumer regarding the consumer's one or more symptoms;
receiving a selection from the consumer of one of the identified one or more medical service providers appropriate to consult with the consumer regarding the consumer's one or more symptoms; and
establishing a communication channel between the device used by the consumer and a device used by the selected medical service provider.

8. The one or more machine-readable storage media of claim 7, wherein the one or more processing devices is a brokerage system, and wherein accessing the data repository that stores the information pertaining to the medical service providers comprises:
accessing a data repository that is external to the brokerage system and is integrated with a practice management system for medical service providers, with the external data repository storing information pertaining to the medical service providers associated with the practice management system, including present availability of the medical service providers associated with the practice management system for participating in a consultation and qualifications of the medical service providers associated with the practice management system; and
wherein determining which of the medical service providers are presently available comprises:
determining, based on the information accessed from the external data repository, which of the medical service providers associated with the practice management system are presently available.

9. The one or more machine-readable storage media of claim 7, wherein identifying, from qualifications of the presently available medical service providers, one or more medical service providers appropriate to consult with the consumer regarding the consumer's one or more symptoms comprises:
identifying, in the accessed information, symptom based attributes of the presently available medical service providers, with a symptom based attribute specifying symptoms that are appropriate for a particular medical service provider to address with the consumer.

10. The one or more machine-readable storage media of claim 9, wherein the operations further comprise:
comparing the symptoms based attributes to the one or more terms included in the request;
determining, based on comparing, a match between one of the symptom based attributes and at least one of the one or more terms; and
identifying a medical service provider associated with the symptom based attribute matching the at least one of the one or more terms included in the request.

11. The one or more machine-readable storage media of claim 7, wherein the operations further comprise:
generating a graphical user interface that when rendered on a display device, renders:
visual representations of the identified one or more medical service providers appropriate to consult with the consumer regarding the consumer's one or more symptoms;
wherein transmitting, to the device used by the consumer, the information comprises:
transmitting the graphical user interface to the device used by the consumer.

12. The one or more machine-readable storage media of claim 7, wherein the operations further comprise:
determining, based on contents of the request, that the consumer is requesting a consultation with a medical service provider associated with a provider practice and appropriate for a consultation regarding the one or more symptoms of the consumer;
wherein accessing the data repository comprises:
accessing the data repository for information pertaining to medical service providers associated with the particular provider practice, with the accessed information including present availability of the medical service providers associated with the particular provider practice for participating in a consultation and qualifications of the medical service providers associated with the particular provider practice.

13. A system comprising:
one or more processing devices; and
one or more machine-readable storage media storing instructions that are executable by the one or more processing devices to perform operations comprising:
receiving a request from a consumer of medical services to consult with a medical service provider, with the request comprising one or more terms indicative of one or more symptoms of the consumer;
processing the terms to establish one or more symptoms of the consumer of medical services;
accessing a data repository that stores information pertaining to medical service providers, including present availability of the medical service providers for participating in a consultation and qualifications of the medical service providers;
determining which of the medical service providers are presently available;
identifying, from the qualifications of the presently available medical service providers and the one or more terms included in the request, one or more medical service providers appropriate to consult with the consumer regarding the consumer's determined one or more symptoms;
transmitting, to a device used by the consumer, information indicative of the identified one or more medical service providers appropriate to consult with the consumer regarding the consumer's one or more symptoms;
receiving a selection from the consumer of one of the identified one or more medical service providers appropriate to consult with the consumer regarding the consumer's one or more symptoms; and
establishing a communication channel between the device used by the consumer and a device used by the selected medical service provider.

14. The system of claim 13, wherein the one or more processing devices is a brokerage system, and wherein accessing the data repository that stores the information pertaining to the medical service providers comprises:
accessing a data repository that is external to the brokerage system and is integrated with a practice management system for medical service providers, with the external data repository storing information pertaining to the medical service providers associated with the practice management system, including present availability of the medical service providers associated with the practice management system for participating in a consultation and qualifications of the medical service providers associated with the practice management system; and
wherein determining which of the medical service providers are presently available comprises:
determining, based on the information accessed from the external data repository, which of the medical service providers associated with the practice management system are presently available.

15. The system of claim 13, wherein identifying, from qualifications of the presently available medical service providers, one or more medical service providers appropriate to consult with the consumer regarding the consumer's one or more symptoms comprises:
identifying, in the accessed information, symptom based attributes of the presently available medical service providers, with a symptom based attribute specifying symptoms that are appropriate for a particular medical service provider to address with the consumer.

16. The system of claim 15, wherein the operations further comprise:
comparing the symptoms based attributes to the one or more terms included in the request;
determining, based on comparing, a match between one of the symptom based attributes and at least one of the one or more terms; and
identifying a medical service provider associated with the symptom based attribute matching the at least one of the one or more terms included in the request.

17. The system of claim 13, wherein the operations further comprise:
generating a graphical user interface that when rendered on a display device, renders:
visual representations of the identified one or more medical service providers appropriate to consult with the consumer regarding the consumer's one or more symptoms;
wherein transmitting, to the device used by the consumer, the information comprises:
transmitting the graphical user interface to the device used by the consumer.

18. The system of claim 13, wherein the operations further comprise:
determining, based on contents of the request, that the consumer is requesting a consultation with a medical service provider associated with a provider practice and appropriate for a consultation regarding the one or more symptoms of the consumer;
wherein accessing the data repository comprises:
accessing the data repository for information pertaining to medical service providers associated with the particular provider practice, with the accessed information including present availability of the medical service providers associated with the particular provider practice for participating in a consultation and qualifications of the medical service providers associated with the particular provider practice.
